(19) United States
(12) Patent Application Publication
(10) Pub. No.: US 2009/0207617 A1
(43) Pub. Date: Aug. 20, 2009

(54) LIGHT EMITTING DIODE (LED) CONNECTOR CLIP

(76) Inventors: Viren B. Merchant, Canton, MI (US); Jeff C. Lin, Novi, MI (US); Andrew Z. Glovatsky, Plymouth, MI (US)

Correspondence Address: VISTEON/BRINKS HOFER GILSON & LIONE, 524 South Main Street, Suite 200, Ann Arbor, MI, 48104, US

(21) Appl. No.: 12/034,452

(22) Filed: Feb. 20, 2008

(51) Int. Cl. F21V 19/00

(52) U.S. Cl. 362/294

(57) ABSTRACT

An LED package holder for holding and electrically connecting an LED package. The LED package holder includes a housing having an aperture defined therein and portions defining a recess. A plurality of contact features are retained by the housing and extend into the aperture. Each contact feature has an exposed portion configured to engage an LED electric terminal of an LED package that is received within the aperture. A heat sink, also retained by the housing, is at least partially located within the recess of the housing and configured to draw heat away from the LED package received within the aperture.

### BACKGROUND

1. Field of the Invention

The present invention generally relates to light-emitting diode (LED) packaging. More specifically, the invention relates to LED packaging for motor vehicle headlamp and other applications.

2. Description of Related Art

An LED is one type of semiconductor that generates light when voltage is applied to it. There are various advantages to using LEDs in vehicle headlamp applications, such as long lifetime, low drive voltage, high vibration resistance, and high tolerance to repeated power switching. An LED is typically provided in an LED package that provides optics for the LED, such as a dome, and LED terminals for electrical connection. The LED terminals are typically provided having one of several variations, such as gull leads (conductors extending from the LED) or flat terminal strips.

The state of current LED lighting technology for headlamps is generally limited by the light output of LEDs. LED manufacturers are working to increase the lumen output of their devices. The current ratings are in the range of 30-50 lm/W. It is estimated that LEDs will be approaching an output of 80-100 lm/W in the next few years, which will reduce the number of LEDs needed to generate a legal light output. In order to effect these results, most improvements will require packaging the LEDs in an efficient manner and providing adequate thermal heatsinking.

In vehicle headlamp applications, typical methods of providing electrical connection to LED packages include soldering the LED terminals to a printed wiring board, utilizing a wave soldering or reflow process, and/or crimping the LED terminals to wiring. Typically, an LED package is first connected to a printed wiring board or a Thermal Clad substrate (T-Clad), and then secondarily, the printed wiring board or T-Clad utilizes another electrical connection, such as a header or board connector, for outer interconnection within a circuit. These types of LED terminal connections may not be robust because, without also having mechanical interlocking features, the connections may separate. In addition, the installation process may be costly due to material costs for multiple interconnection processes. The installation process may also be open to error because the installer must undertake multiple steps, some of which may require a high amount of precision. These factors provide for an expensive packaging design for LEDs.

### BRIEF SUMMARY

In satisfying the above need, as well as overcoming the enumerated drawbacks and other limitations of the related art, the present invention provides an LED package holder that is configured to provide an electrical interconnection to an LED package, while including various other useful components, such as a heat sink, lens-alignment features, a lens, a connector shroud, and/or biasing contact features.

In one aspect, an LED package holder for holding and electrically connecting an LED package includes a housing having an aperture defined therein and portions defining a recess. A plurality of contact features are retained by the housing and extend into the aperture. Each contact feature has an exposed portion configured to engage an LED electric terminal of an LED package received within the aperture. A heat sink is also retained by the housing and is at least partially located within the recess of the housing. The heat sink is configured to draw heat away from the LED package received within the aperture.

In another aspect, an LED package holder for holding and electrically connecting an LED package includes a housing having an aperture defined therein and a lens-alignment feature configured to align a lens with the housing. The LED package holder also has a plurality of contact features, which are retained by the housing. Each contact feature has an exposed portion to engage an LED electric terminal of an LED package received within the aperture.

In yet another aspect, an LED package holder for holding and electrically connecting an LED package includes a housing having an aperture defined therein and a lens connected to the housing and disposed over the aperture. A plurality of contact features are retained by the housing and extend into the aperture. Each contact feature has an exposed portion that engages an LED electric terminal of an LED package received within the aperture.

In still another aspect, an LED package holder for holding and electrically connecting an LED package includes a housing, a plurality of contact features, a heat sink, a connector shroud, a lens-alignment feature, and a lens. The housing has an aperture defined therein and portions defining a recess. The plurality of contact features are retained by the housing and extend into the aperture. Each contact feature has an exposed portion that engages an LED electric terminal of an LED package received within the aperture and to bias the LED package so as to secure the LED package to a surface. The heat sink is also retained by the housing and is at least partially located within the recess of the housing to draw heat away from the LED package within the aperture. The connector shroud is integrally formed with the housing and has portions forming a cavity to receive a connector therein. A portion of each contact extends into the connector shroud and engages connector terminals when a connector is inserted into the cavity of the connector shroud. The connector shroud has a latching feature that releasably retains the connector within the cavity of the connector shroud. The lens is connected to the housing and disposed over the aperture while a lens-alignment feature aligns the lens with the housing for that connection.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of an LED package holder having an LED package disposed therein, according to the principles of the present invention;

FIG. 2 is a perspective view the LED package holder of FIG. 1, with the LED package removed;

FIG. 3 is a plan view of the LED package holder of FIG. 1, having LED locating features locating an LED package therein;

FIG. 4 is a cross-sectional view of the LED package holder of FIGS. 1-3, having a lens connected to the housing of the LED package holder;

FIG. 5 is another cross-sectional view of the LED package holder of FIGS. 1-4, having a different lens attached to the housing, and the LED package holder being attached to a secondary heat sink; and

FIG. 6 is another perspective view of the LED package holder of FIGS. 1-5, having an alternative set of contact features, in accordance with the principles of the present invention.

### DETAILED DESCRIPTION

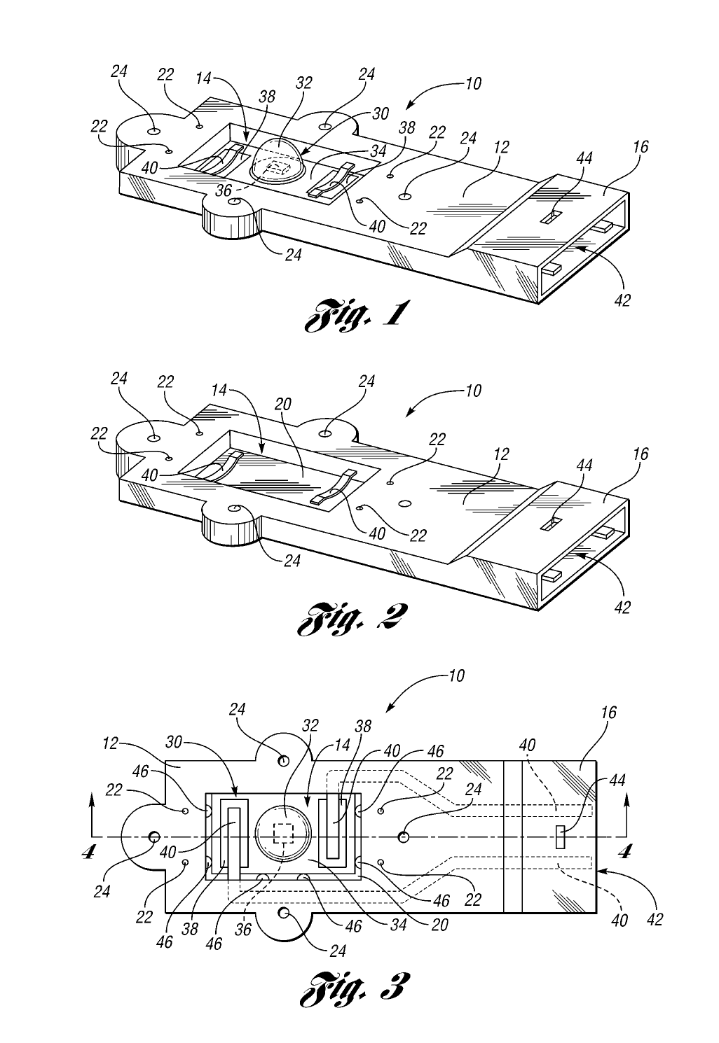

Referring now to FIGS. 1-3, an LED package holder for holding and electrically connecting an LED package is illustrated therein and generally designated at 10. The LED package holder 10 has an electrically insulative housing 12 defining an aperture 14 therein. The housing 12 is preferably made of a moldable, non-conducting material, such as rubber or plastic. More preferably, the housing 12 is formed of an engineering plastic, for example, a nylon such as polyamide 66 (PA66) or polyamide 6 (PA6), polybutylene terephthalate (PBT), polyethylene terephthalate (PET), polyester, polyetherimide (PEI), liquid crystal polymer (LCP), and/or polychlorinated terphenyl (PCT) plastic fillers. Glass fillers may be added to the material of the housing 12 to improve the strength and thermal dimensional stability.

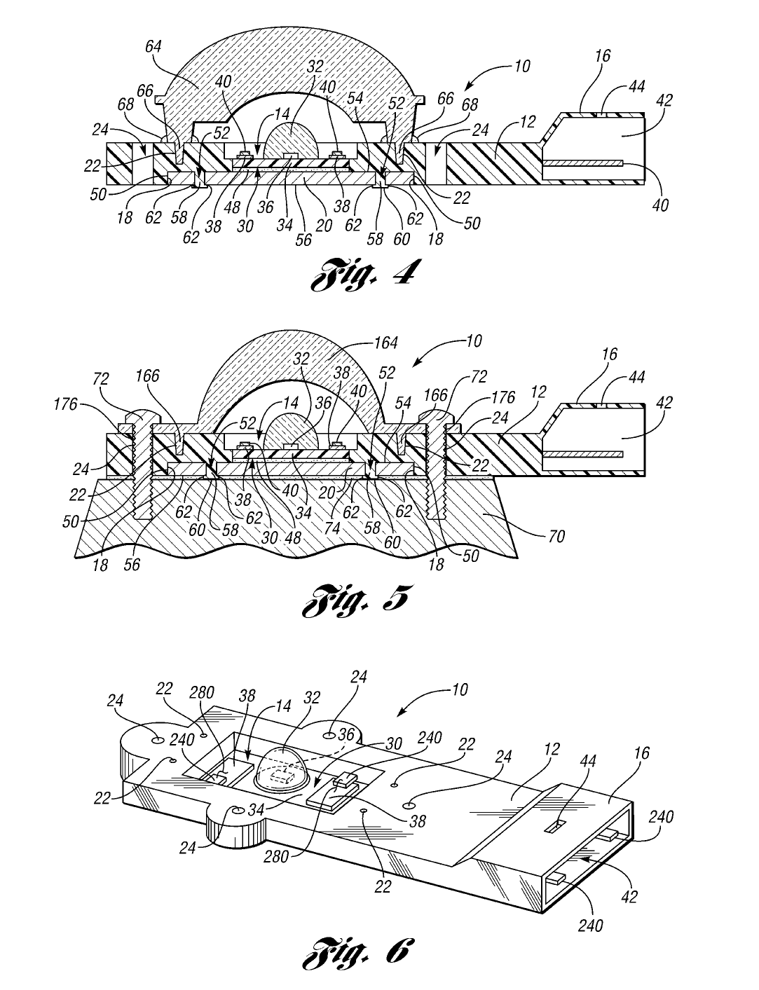

The housing 12 may have one or more alignment features 22 for aligning a lens (shown in FIGS. 4-5), which is described in further detail below. The housing 12 may also have a plurality of attachment features 24, such as screw holes as shown, for attaching the housing 12 to an outside object, such as a secondary heat sink, which is described in further detail below. A primary heat sink 20 (seen in FIG. 2) is retained by the housing 12. This feature is also described in further detail below.

An LED package 30 is disposed within the aperture 14, such that the dome 32 of the LED package 30 protrudes from the aperture 14. The LED package 30 includes a substrate 34 upon which the LED chip 36 is disposed and electric terminals 38 for electrically connecting the LED chip 36 within a circuit. It should be understood that the LED package 30 could have other configurations, without falling beyond the spirit and scope of the present invention, such as a flat optic instead of a dome 32. The LED electrical terminals 38 could be of any suitable type, as known in the art. For example, the LED electric terminals 38 could be Ni/Au plated, Ni/Sn plated, or clad aluminum pads.

A pair of contact features 40 is retained by the housing 12 and extends into the aperture 14 from the housing 12 to electrically connect to the electric terminals 38 of an LED package 30. Each contact feature 40 has an exposed portion that engages the LED electric terminals 38. In the embodiment of FIGS. 1-5, the exposed portions of the contact features 40 exhibit a spring force to bias the LED package 30 to a surface, such as the surface of the heat sink 20, which secures the LED package 30 in the LED package holder 10. In other words, the contact features 40 are spring clips that may operate to electrically connect and mechanically secure the LED package 30 within the LED package holder 10. As shown, each contact feature 40 has a bend defined therein toward the surface of the heat sink, which presses against an LED electric terminal 38 biases the LED package 30 within the LED holder package 10. In the alternative, or in addition, the contact features 40 could be provided with crimps, corrugations, or other features to help secure the LED package 30 within the LED package holder 10, such as those disclosed in U.S. patent application Ser. No. 11/686,101, which is herein incorporated by reference in its entirety. Because a mechanical force holds the LED package 30 within the LED package holder 10, soldered, wire crimped, and/or welded connections may be avoided if desired. In the alternative, soldering, wire crimping, and welding could be used along with the biasing contact features 40 of the present embodiment.

The contact features 40 may be molded into the housing 12, or they may be retained by the housing 12 in another way, such as by being press-fit to the housing 12, snapped into connecting features (not shown) located on the housing 12, heat staked to the housing 12, or adhesively attached to the housing 12. The contact features 40 extend through an interior portion of the housing 12 (see FIG. 3, for example) and into a cavity 42 of a connector shroud 16. In the alternative, the contact features 40 could extend along the exterior of the housing 12.

Each contact feature 40 is shown molded into the housing 12 with a free end extending into the aperture 14. In the alternative, each contact feature 40 could be molded into, or retained by, two opposite sides of the aperture 14 of the housing 12, such that the contact features 40 extend across the aperture 14 to contact the LED electric terminals 38, but there are no “free ends” within the aperture 14. This configuration could operate similarly to the contact features 40 as shown, but with improved strength.

The contact features 40 may be formed of any suitable material or combination of materials, so long as they are configured to connect the LED package 30 within a circuit. For example, the contact features 40 may be formed of metal alloys, such as Be—Cu, spring steel, brass, Tin-Bronze, or Cu—Ni. In the alternative, the contact features 40 could be formed of a platable grade polymer and over-plated with a conducting material. The contact features 40 may have a surface finish comprising Ni/Sn or Ni/Au, for example.

The connector shroud 16 is integrally formed with the housing 12. In the embodiment illustrated, the connector shroud 16 is unitarily formed with the housing 12 and therefore made of the same material as the housing 12. The connector shroud 16 is configured to receive a connector (not shown) therein to connect the LED package 30 within a circuit. Thus, portions of the contact features 40 extend into a cavity 42 of the connector shroud 16. These portions of the contact features 40 are configured to engage electrical leads of the connector when the connector is inserted into the cavity 42 of the connector shroud 16. The connector could be of a terminal category 0 or 1 type, or any other suitable connector. It is contemplated that the connector may form a part of a wire harness to interconnect the LED package 20 within a circuit. The connector shroud 16 optionally has a latching feature 44 configured to releasably retain the connector within the cavity 42 of the connector shroud 46. For example, the latching feature 44 could be an aperture that retains a displaceable release button of the connector. The connector shroud 16 and contact features 40 may be formed by any suitable method and may be formed, for example, using the method of U.S. patent application Ser. No. 11/778,945, which is herein incorporated by reference in its entirety.

The housing 12 optionally has locating features 46 to aid in positioning the LED package 30 within the aperture 14 of the housing 12 (shown only in FIG. 3). The locating features 46 of FIG. 3 have a partial cylindrical shape and are located on three sides of the aperture 14. In the alternative, the locating features 46 could have other shapes and be located elsewhere, or on more or fewer sides of the aperture 14, without falling beyond the spirit and scope of the present invention.

Referring now to FIG. 4, the primary heat sink 20 is retained by the housing 12 such that the heat sink 20 conducts heat away from the LED package 30. A layer of adhesive or thermal interface material 48 is optionally disposed between the LED package 30 and the heat sink 20. The housing 12 has portions 18 defining a recess, such that the heat sink 20 may be located at least partially within the recess, between the portions 18 forming the recess. The portions 18 forming the recess may also define the aperture 14, as shown in FIG. 2, or in the alternative, the aperture 14 could be larger or smaller than the recess. The portions 18 defining the recess receive the heat sink 20 so as to position the heat sink 20 against the bottom of the LED package 30. In order to draw heat away from the LED package 30, the heat sink 20 is formed of a conductive material, such as metal.

The heat sink 20 may be retained within the recess of the housing 12 with an interference fit. In other words, the heat sink 20 may be retained by the housing by virtue of friction between the portions 18 forming the recess and sides 50 of the heat sink 20, when there is a close fit between the heat sink 20 and the portions 18 forming the recess, with little or no gap between the sides 50 of the heat sink 20 and the portions 18 forming the recess.

In addition, or in the alternative, the heat sink 20 may be retained with the housing 12 through adhesive bonding (not shown). For example, adhesive bonding could be located between various portions of the housing 12 and the heat sink 20 to secure the heat sink 20 to the housing 12. Among other places, the adhesive material could be located between the sides 50 of the heat sink 20 and the portions 18 forming the recess within the housing 12.

In addition to either or both the interference fit and the adhesive bonding, the heat sink 20 could be retained by the housing 12 by heat staking. For example, as seen in FIG. 4, the heat sink 20 may have portions defining a plurality of holes 52, for example, two or four holes, which extend through the heat sink 20 from a top surface 54 to a bottom surface 56. The housing 12 may have a plurality of corresponding projections 58 extending through each hole 52. To heat stake the heat sink 20 to the housing 12, distal portions 60 of the projections are melted to deform the ends of projections 58, forming lips 62 that retain the projections 58 within the holes 52, and thus connect the heat sink 20 to the housing 12. Heat staking the heat sink 20 to the housing 12 may provide a controlled constant force against the LED package 30 to the contact features 40.

Each feature for retaining the heat sink 20 to the housing 12 as described above (e.g., the interference fit, adhesive bonding, and heat staking elements) may be used separately or together with the other features for retaining the heat sink 20. In the alternative, any other suitable feature for retaining the heat sink 20 to the housing 12 may be used, as would be known to one having ordinary skill in the art, such as utilizing fasteners to retain the heat sink 20 to the housing 12.

With reference to FIG. 4, a lens 64 is retained to the housing 12. The lens 64 has projecting features 66 which extend into the lens-alignment features 22. The projecting features 66 may be held to the housing 12 by virtue of an interference fit between the lens-alignment features 22 and the projecting features 66. In the alternative, the lens-alignment features 22 may be configured merely to align the lens 64 without retaining the lens 64, in which case the lens 64 may be retained to the housing 12 by other means, such as by being adhesively bonded with adhesive bonding material 68. It should be understood that the lens 64 may be retained to the housing 12 with both an interference fit between the projecting features 66 and the lens-alignment features 22 and adhesive bonding material 68, as well as any other suitable retaining means.

The lens 64 is preferably disposed over the LED package 30 to help focus light rays emanating from the LED package 30. The lens 64 could be of any suitable type, depending on the application. For example, the lens 64 could be a collimating lens or a light-spreading lens. The lens 64 is preferably formed a light-transmitting or transparent material, such as polycarbonate or polymethylmethacrylate (PMMA).

With reference to FIG. 5, the LED package holder 10 is shown having similar features as shown in the previous figures. For example, the LED package holder 10 has a housing 12 having lens-alignment features 22, a heat sink 20 retained by the housing 12, and a connector shroud 16 unitarily formed with the housing 12. A lens 164, which is somewhat different from the lens 64 of FIG. 4, is connected to the housing 12. Like the lens 64 of FIG. 4, the lens 164 of FIG. 5 has projecting features 166 that extend into the lens-alignment features 22 of the housing 12 to align the lens 164 with the housing 12. The lens 164 is shaped somewhat differently than the lens 64 of FIG. 4, and it has a pair of apertures 176 for connecting the lens 164 to the housing 12. The lens 164 and the housing 12 are fastened to a secondary heat sink 70 with a pair of fasteners 72 that extend through the screw holes or attachment features 24 of the housing 12 and through the apertures 176 of the lens 164. Each fastener 72 is shown as a screw, but each fastener 72 may alternatively be any other suitable type of fastener, such as a bolt, rivet, or nail. A layer of adhesive or thermal interface material 74 may be disposed between the LED package holder 10 and the secondary heat sink 70. The secondary heat sink 70 will help to further draw heat away from the LED package 30.

With reference to FIG. 6, the LED package holder 10 is shown having most of the same features as previously shown, such as a housing 12 having a connector shroud 16 formed unitarily therewith and an LED package 30 disposed within an aperture 14 of the housing 12. The LED package has a dome 32, a substrate 34, an LED chip 36, and a pair of LED electric terminals 38.

A pair of contact features 240 extends through the housing 12, each having an exposed end portion disposed within the aperture 14 of the housing 12. The contact features 240 are flat leads that extend over the LED electric terminals 38 and are electrically connected therewith via wire bonds 280. The wire bonds 280 are preferably formed of aluminum or gold and are preferably potted with a sealant having a low modulus of elasticity, such as Silicone. Such wire bond interconnections may be suitable for high temperature and high vibration applications because they may help avoid issues of fretting or micro-motion between the LED electric terminals 38 and the contact features 240. The contact features 240 may be configured to locate the LED package 30 within the LED package holder 10 by extending over the LED package 30, such that the LED package 30 is inserted tightly between the LED package 30 and the heat sink 20. The contact features 240 may optionally bias the LED package to the heat sink 20, as described above.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. An LED package holder for holding and electrically connecting an LED package, the holder comprising:
a housing having an aperture defined therein and portions defining a recess;
a plurality of contact features extending into the aperture, each contact feature being retained by the housing and having an exposed portion configured to engage an LED electric terminal of an LED package received within the aperture; and
a heat sink retained by the housing, the heat sink being at least partially located within the recess of the housing and being configured to draw heat away from the LED package received within the aperture.

2. The LED package holder of claim 1, wherein the heat sink is retained by the housing with an interference fit.

3. The LED package holder of claim 1, wherein the heat sink is retained by the housing with adhesive bonding.

4. The LED package holder of claim 1, wherein the heat sink is retained by the housing by heat staking.

5. The LED package holder of claim 4, wherein the heat sink has portions forming a plurality of holes therethrough, the housing having a plurality of projections, each projection extending through one of the plurality of holes and having a deformed end protruding therefrom to connect to the heat sink to the housing.

6. The LED package holder of claim 1, wherein the contact features are configured to bias the LED package and to secure the LED package to a surface.

7. The LED package holder of claim 6, wherein the heat sink comprises the surface to which the LED package is secured.

8. The LED package holder of claim 6, wherein each contact feature has a portion molded into the housing.

9. The LED package holder of claim 1, further comprising a connector shroud integrally formed with the housing, the connector shroud having portions forming a cavity and being configured to receive a connector therein, each contact feature having a portion extending into the cavity of the connector shroud and being configured to engage connector terminals when a connector is inserted into the connector shroud, the connector shroud comprising a latching feature configured to releasably retain the connector within the cavity of the connector shroud.

10. The LED package holder of claim 1, wherein the aperture of the housing has locating features to aid in positioning the LED package within the aperture.

11. The LED package holder of claim 1, further comprising an LED package disposed within the aperture, the LED package having a plurality of LED electric terminals, each LED electric terminal being electrically connected to one of the contact features, each of the contact features biasing the LED package to a surface.

12. An LED package holder for holding and electrically connecting an LED package, the holder comprising:
a housing having an aperture defined therein and a lens-alignment feature configured to align a lens with the housing; and
a plurality of contact features, each contact feature being retained by the housing and having an exposed portion configured to engage an LED electric terminal of an LED package received within the aperture.

13. The LED package holder of claim 12, further comprising a lens aligned with the lens-alignment feature and connected to the LED package holder.

14. The LED package holder of claim 13, wherein the lens has an interference fit with the lens-alignment feature.

15. The LED package holder of claim 13, wherein the lens is adhesively bonded to the LED package holder.

16. The LED package holder of claim 12, wherein each contact feature extends into the aperture and is configured to bias the LED package to secure the LED package to a surface.

17. The LED package holder of claim 16, further comprising a connector shroud integrally formed with the housing, the connector shroud having portions forming a cavity and being configured to receive a connector therein, each contact feature having a portion extending into the connector shroud and being configured to engage connector terminals when a connector is inserted into the connector shroud, the connector shroud comprising a latching feature configured to releasably retain the connector within the cavity of the connector shroud.

18. The LED package holder of claim 12, further comprising an LED package disposed within the aperture, the LED package having a plurality of LED electric terminals, each of the LED electric terminals being electrically connected to one of the contact features, each of the contact features biasing the LED package to a surface.

19. The LED package holder of claim 12, further comprising a heat sink retained by the housing, the heat sink being configured to draw heat away from the LED package received within the aperture.

20. An LED package holder for holding and electrically connecting an LED package, the holder comprising:
a housing having an aperture defined therein;
a plurality of contact features extending into the aperture, each of the contact features being retained by the housing and having an exposed portion configured to engage an LED electric terminal of an LED package received within the aperture; and
a lens connected to the housing and disposed over the aperture.

21. The LED package holder of claim 20, wherein each of the contact features is configured to bias the LED package to secure the LED package to a surface.

22. The LED package holder of claim 21, further comprising a connector shroud integrally formed with the housing, the connector shroud having portions forming a cavity and being configured to receive a connector therein, each of the contact features having a portion extending into the connector shroud and being configured to engage connector terminals when a connector is inserted into the cavity of the connector shroud, the connector shroud having a latching feature configured to releasably retain the connector within the cavity of the connector shroud.

23. The LED package holder of claim 20, further comprising a heat sink retained by the housing, the housing having portions defining a recess therein, the heat sink being at least partially located within the recess of the housing and being configured to draw heat away from the LED package received within the aperture.

24. An LED package holder for holding and electrically connecting an LED package, the holder comprising:
a housing having an aperture defined therein and portions defining a recess;
a plurality of contact features extending into the aperture and being retained by the housing, each of the contact features having an exposed portion configured to engage an LED electric terminal of an LED package received within the aperture, each of the contact features being configured to bias the LED package to secure the LED package to a surface;
a heat sink retained by the housing, the heat sink being at least partially located within the recess of the housing and being configured to draw heat away from the LED package received within the aperture;
a connector shroud integrally formed with the housing, the connector shroud having portions forming a cavity and being configured to receive a connector therein, each of the contact features having a portion extending into the connector shroud and being configured to engage connector terminals when a connector is inserted into the cavity of the connector shroud, the connector shroud having a latching feature configured to releasably retain the connector within the cavity of the connector shroud; and
a lens connected to the housing and disposed over the aperture, the housing having a lens-alignment feature configured to align the lens with the housing.
